(19) United States
(12) Patent Application Publication
(10) Pub. No.: US 2009/0256296 A1
(43) Pub. Date: Oct. 15, 2009

(54) SEGMENTED FIBER COMPOSITE LEAF SPRING AND METHOD FOR PRODUCING THE SAME

(75) Inventors: Clemens Aulich, Magdeburg (DE); Rainer Förster, Odenthal-Voiswink (DE); Heiko Kempe, Magdeburg (DE)

Correspondence Address: Flindt Intellectual Property Law Group, PLLC, P.O. Box 1390, Issaquah, WA, 98027-0057, US

(73) Assignee: IFC COMPOSITE GMBH, Haldensleben (DE)

(21) Appl. No.: 12/094,148

(22) PCT Filed: Nov. 4, 2006
(86) PCT No.: PCT/DE2006/001941

§ 371 Date: Nov. 17, 2008

(30) Foreign Application Priority Data
Nov. 16, 2005 (DE) 10 2005 055 050.9

(51) Int. Cl. F16F 1/368; B29C 71/02

(52) U.S. Cl. 267/148; 264/236

(57) ABSTRACT

Leaf spring (1) for a wheel suspension on a motor vehicle is produced from a fiber composite material. Leaf spring includes a central longitudinal section (3) and two adjoining axial end sections (10, 11) tapered in relation to the width of the leaf spring. Resin-impregnated unidirectional fibers (23) extend axially, without being cut, between the axial ends (4, 5) of the leaf spring (1). An unfinished leaf spring (2) includes axial end sections (10, 11) with a substantially V-shaped recess or final geometry, thereby forming two legs (8, 9) that extend at angles to the longitudinal extension of the unfinished leaf spring (2), said legs (8, 9) resting closely against each other in the finished leaf spring (1). Individual elongate segments (6; 13, 14) of substantially identical geometry which are separately produced as fiber composite bodies and which are assembled before being cured form the leaf spring (1, 2).

### CROSS REFERENCE TO RELATED APPLICATIONS

The present application claims priority under 35 U.S.C. §120 to International Patent Application PCT/DE2005/000153, filed Nov. 4, 2006, entitled “SEGMENTED FIBER COMPOSITE LEAF SPRING AND METHOD FOR PRODUCING THE SAME” and international priority under 35 U.S.C. § 119 to co-pending German Patent Application DE 10 2005 055 050.9, filed Nov. 16, 2005, entitled “SEGMENTIERTE FASERVERBUND-BLATTFEDER UND VERFAHREN ZUR HERSTELLUNG DERSELBEN” and hereby incorporates the entire contents and disclosures of these applications herein by reference in its entirety.

### TECHNICAL FIELD

Embodiments of the invention relate to a leaf spring for a wheel suspension on a vehicle. More specifically, embodiments of the invention relate to a leaf spring apparatus produced from a fiber composite material and methods of manufacturing the same.

### BACKGROUND

Leaf springs are commonly used for wheel suspensions in motor vehicles in order to provide cushioning against uneven road surfaces. Such vehicles may include, but are not limited to, passenger vehicles, trucks, and other utility vehicles, and may also include railcars and similar vehicles.

Leaf springs made of steel have been known for some time. In such springs, narrow steel sheets of decreasing lengths are placed on top of each other in order to achieve a variable spring constant with increasing load. The sheets of the leaf springs are joined into a unit by means of clamps and/or screws. When mounting a leaf spring on a vehicle, this is done transversely to the direction of travel, for example, wherein the center area of the leaf spring is specified on the vehicle chassis, while the two axial ends of the leaf springs are arrayed in the area of the suspension for the right and left vehicle wheels. Even though a metal leaf spring is comparatively more cost-effective to manufacture and more reliable in operation, it nevertheless has the disadvantage of being heavy, which contributes to a relatively high vehicle weight and thus ultimately causes higher fuel consumption.

Also known are leaf springs made of fiber composite materials that are formed, for example, from glass or carbon fibers impregnated with synthetic resins, and which have comparable suspension properties with significantly less weight than steel leaf springs of the same size. Such fiber composite leaf springs are produced, for example, from individual resin-impregnated fiber layers, known by the term “prepreg.” These prepregs are manufactured in and/or cut to the desired form and placed on top of each other in a press mold that corresponds to the dimensions of the leaf spring. The unfinished leaf spring in the press mold is then cured using pressure and heat.

U.S. Patent Application Publication US 2003/0122293 A1 describes a leaf spring made of a fiber composite material consisting of a single piece with a central arched section and peripheral sections on the ends. The peripheral sections have an eyelet on their respective axial ends with an opening to receive a bolt for the purpose of mounting the leaf spring to the vehicle chassis. The disadvantage of this lies in integrating the mounting eyelet into the leaf spring, which can be accomplished only with a structurally complex press mold or by a punching process that penetrates through the fibers.

In other leaf spring designs made of fiber composite materials, the end sections are beveled. Here each end section is cut to the appropriate beveled form after the leaf spring is cured. As a result, the fibers of the material are also cut. With long-term variable loads on the leaf spring, the sites of the cuts often develop cracks that extend outward from the sites of the cuts and primarily run parallel to the longitudinal extension of the fibers. These cracks may in turn cause the leaf spring to break.

EPO Patent Publication EP 0 093 707 B1 and the parallel U.S. Pat. No. 4,557,500 B1 describe a leaf spring produced from a fiber composite material that is narrower and thicker on its axial ends than in a central, rectangular section. In this design, the area of the axial ends of the leaf spring can be somewhat trapezoidal in top view. According to another variant, the surface of the rectangular cross-sections of the leaf spring can be constant from one end of the spring to the other. In another structural type of this leaf spring, the composite fibers are uncut from one axial end to the other. The geometry of the leaf spring is created by press molds during its manufacture.

Also known from German Patent Publication DE 10 2004 010 768 A1 of the applicant is a leaf spring produced from a fiber composite material with a central longitudinal extension and axial ends for a wheel suspension on a vehicle, in which the axial ends are formed tapering with respect to the leaf spring width, and in which the axially orientated fibers of the fiber composite material extend, without being cut, up to the terminal edge of the leaf spring. In addition, this leaf spring is produced from resin-impregnated fiber layers that have a substantially V-shaped geometry or a V-shaped recess on the axial ends in top view during the manufacture of the leaf spring, and thus form two limbs lying at an angle to the longitudinal extension of the leaf spring. These two limbs rest closely against each other in the manufacturing process and are cured so that the final manufactured leaf spring is somewhat trapezoidal in the area of its ends and has no thickening of the material in this area.

Also known from this publication is that the thickness of the leaf spring can be reinforced in its central area by means of geometrically simple, rectangular fiber layers, using fiber layers fashioned appropriately to give the V-shaped axial ends of the leaf spring and extending across the entire length of the part.

A leaf spring according to German Patent Publication DE 10 2004 010 768 A1 has several advantages because it can have essentially constant cross-section surfaces throughout almost its entire length as well as a largely constant thickness with a narrower width on the axial end, without having to be cut on its axial ends.

Given these circumstances, the object of the invention is to improve a leaf spring known from German Patent Publication DE 10 2004 010 768 A1 such that it can be produced at the lowest cost possible with optimal product quality.

### SUMMARY

The achievement of this object is shown with regard to the leaf spring by the features of claim 1. Two production methods are specified in claims 9 and 10. Advantageous embodiments and improvements of the invention are specified in the subclaims.

The invention is based upon the recognition that through the use of largely identical sections of a continuous strip/web of fiber composite material, a fiber composite leaf spring can be produced at low cost, with comparative ease and in different ways.

Thus, according to the features of claim 1, the invention is based upon a leaf spring produced from a fiber composite material, comprising a central longitudinal section and two adjoining axial end sections for a wheel suspension on a motor vehicle, the end sections being tapered in relation to the width of the leaf spring, wherein the leaf spring is constituted of resin-impregnated unidirectional fibers which extend axially, without being cut, between the axial ends of the leaf spring, and in which the axial end sections, before the unfinished leaf spring is finished, have a substantially V-shaped recess or a substantially V-shaped final geometry, thereby forming two legs each that extend at an angle to the longitudinal extension of the unfinished leaf spring, wherein these legs rest closely against each other in the finished leaf spring. Also for the purpose of achieving the object of the invention, this leaf spring is constituted of individual elongate segments of substantially identical geometry, which are separately produced as fiber composite bodies and which are assembled before being cured to give the leaf spring.

Such a leaf spring can also be characterized by the fact that the aforementioned segments are prepregs, which are cut out of a continuous material strip/web by means of two cuts each, with differing, although oblique, cutting angles and resting closely against each other on their longitudinal sides to give the unfinished leaf spring.

According to a first variant of a leaf spring according to the invention, it is preferable that two of the segments cut from the material strip/web rest closely against each other with one of their respective longitudinal sides such that in top view the first segment gives the right half of the leaf spring and the second segment gives the left half, or vice versa.

In order to easily produce the swallowtail-shaped final geometry of the unfinished leaf spring, in another embodiment of the invention the short longitudinal sides of the segments rest closely against each other to give the leaf spring.

The two cutting angles are preferably selected such that the groove angle of the substantially V-shaped final geometry of the unfinished leaf spring is identical to two times the cutting angle a when cutting the segments from the material strip/web.

According to another improvement of the invention, the segments essentially have the thickness of the leaf spring vertical to their width B1 and length L1, or several segments placed on top of each other give the thickness of the leaf spring.

A second variant of a leaf spring formed according to the invention is characterized by the fact that other segments are used for its construction, said segments being cut in an essentially right-angle cut from a material strip/web and having a width B at an angle to their length L that is smaller than the thickness D of these other segments, and that these other segments rest closely against each other with their opposing larger longitudinal sides to give the unfinished leaf spring.

To produce the substantially V-shaped final geometry of the unfinished leaf spring, the leaf spring is constructed according to the second variant such that the segments resting closely against each other with their opposing larger longitudinal sides have differing axial lengths L.

The invention also relates in each case to a method for production of a leaf spring according to the two briefly presented variants. The method for production of the leaf spring according to the first variant involves the following process steps:
Cutting of geometrically largely identical segments from a web/strip of fiber composite material with two cuts each, using oblique cutting angles α or β.
Separation of the segments from each other.
Joining of two segments on their short longitudinal sides.
Repetition of the first three steps until the thickness of the unfinished leaf spring is achieved.
Pivoting/turning of the four legs formed on the ends by the two cuts in the direction of the longitudinal axis of the unfinished leaf spring until the legs rest closely against each other.
Application of a clamping pressure on the unfinished leaf spring in a press mold and curing of the same using heat.

The method for production of the leaf spring according to the second variant involves the following process steps:
Cutting of other, geometrically largely identical segments from a web/strip of fiber composite material with an essentially right-angle cut.
Placement of a number of the other segments against each other or on top of each other on their larger longitudinal sides such that an unfinished leaf spring with a longitudinally layered structure is created from the other segments, wherein the width of the material strip essentially has the thickness D of the unfinished leaf spring and the total of the other segments joined to each other at an angle to the longitudinal extension essentially determines the width of the unfinished leaf spring.
Creation of a V-shaped final geometry of the unfinished leaf spring caused by these other segments with differing axial lengths L resting closely against each other.
Pivoting/turning of the longitudinally layered four legs in the direction of the longitudinal axis of the unfinished leaf spring until the legs rest closely against each other.
Application of a clamping pressure on the unfinished leaf spring in a press mold and curing of the same using heat.

### BRIEF DESCRIPTION OF THE DRAWINGS

The present invention will be described by way of exemplary embodiments, but not limitations, illustrated in the accompanying drawings in which like reference numbers denote similar elements, and in which:

FIG. 1 illustrates a schematic top view of fiber layers in an unfinished leaf spring according to the invention during its production;

FIG. 2 illustrates a leaf spring according to FIG. 1 after its production;

FIG. 3 illustrates a schematic representation of a fiber composite material strip;

FIG. 4 illustrates two segments cut and separated from the material strip according to FIG. 3;

FIG. 5 illustrates an unfinished leaf spring constructed from the two segments according to FIG. 4; and

FIG. 6 illustrates a schematic cross-section A-A through an unfinished leaf spring according to FIG. 1 during its production, which is constructed of segments resting closely against each other on their longitudinal sides.

### DESCRIPTION OF EMBODIMENTS

In the following detailed description, reference is made to the accompanying drawings which form a part hereof wherein like numerals designate like parts throughout, and in which are shown, by way of illustration, specific embodiments in which the disclosure may be practiced. It is to be understood that other embodiments may be utilized and structural or logical changes may be made without departing from the scope of the present disclosure. Therefore, the following detailed description is not to be taken in a limiting sense, and the scope of the present disclosure is defined by the appended claims and their equivalents.

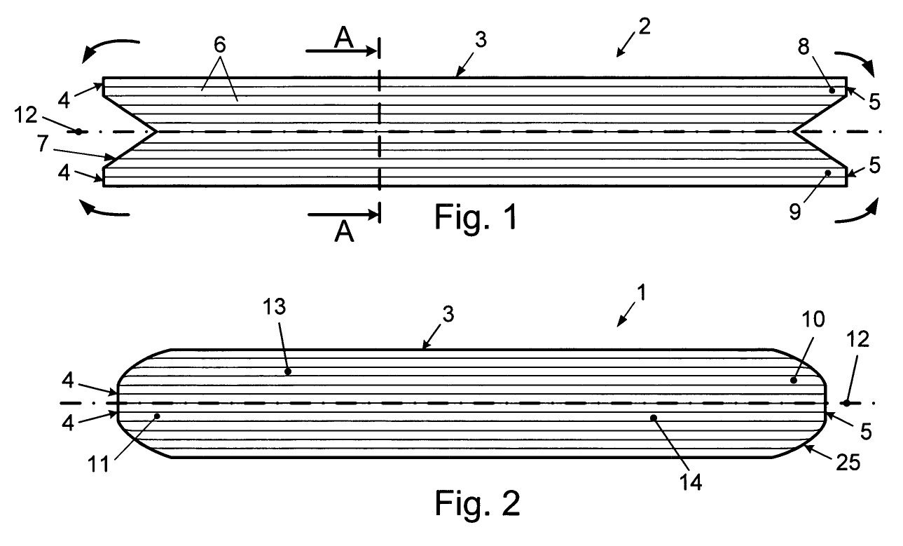

A leaf spring 1 of FIG. 2 according to at least one embodiment of the invention is manufactured in a press mold in a known manner using pressure and heat from a number of resin-impregnated and unidirectional fibers, for example fiberglass, carbon, or aramide, placed on top of each other. For this purpose, initially an unfinished leaf spring 2 schematically shown in FIG. 1 is constructed, which has an essentially rod-shaped circumferential geometry and a central section 3 to which axial and sections 10 and 11 adjoin. The end sections 10, 11 have a somewhat V-shaped recess or V-shaped final geometry 7 such that two legs 8, 9 are formed on each end of unfinished leaf spring 2. These legs 8, 9 are joined to each other prior to the setting of unfinished leaf spring 2 such that a final manufactured leaf spring 1 according to FIG. 2 has sharp or largely rounded axial ends 4, 5.

In order to be able to produce such a leaf spring 1, 2 at low cost and with optimal quality, said leaf spring has the construction schematically shown in the figures. As shown in FIGS. 3 through 5, a leaf spring 1, 2 according to the invention is first produced by cutting off and joining individual sections or segments 13, 14, 15 from a continuous fiber composite material strip 16, which is produced from a prepreg material. Here the prepreg material comprises unidirectional fibers 23 impregnated with synthetic resin 24.

As shown in FIG. 3, segments 13, 14, 15 are cut off by means of cuts 17 and 17′ with a predetermined oblique angle α or β from material strip 16 such that segments 13, 14, 15 each have a substantially rhombus-shaped circumferential geometry in top view, with one long longitudinal side and one comparatively shorter longitudinal side 18, 19, respectively. Width B1 of the segments is small relative to length L1 of the same.

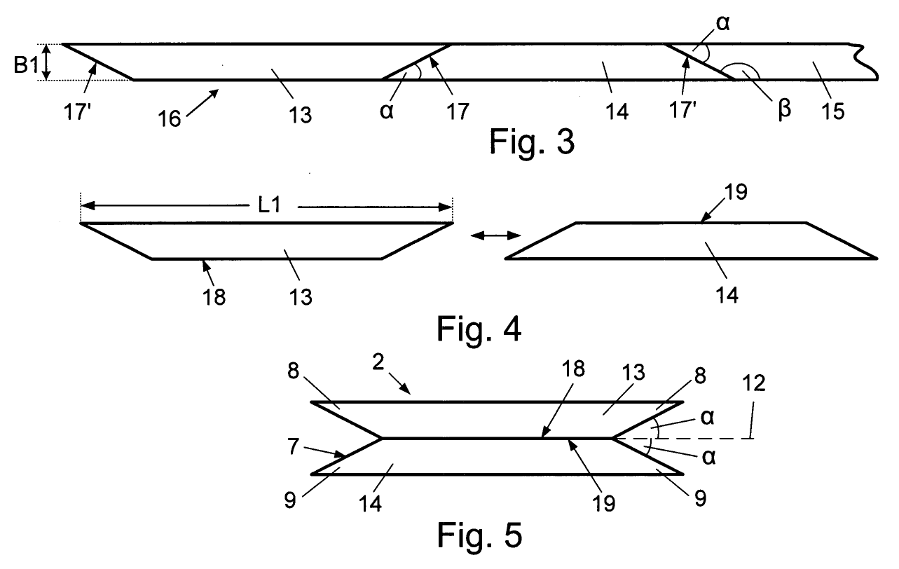

After the cutting off of segments 13, 14, these are separated from each other as shown in FIGS. 4 and 5 and placed against each other on their short and narrow longitudinal sides. In this way, unfinished leaf spring 2 with the respective legs 8, 9 and their V-shaped final geometry 7 are constructed in layers up to the desired thickness. As shown by FIG. 5, the groove angle of this V-shaped final geometry 7 is essentially twice the size of the cutting angle α.

In the unfinished leaf spring 2 produced in this way, the legs 8, 9 are then made to rest closely against each other and unfinished leaf spring 2 is cured in a press mold under application of pressure and heat to a finished leaf spring 1, such as shown in FIG. 1.

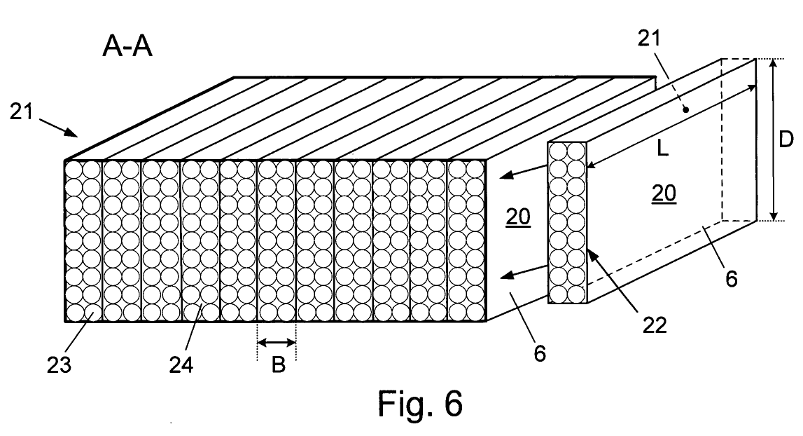

FIG. 6 shows in an enlarged schematic cross-section A-A according to FIG. 1 through an unfinished leaf spring 2, which is constructed from segments 6, which are likewise preferably prepregs, although differing at least with regard to their geometry from the previously described segments 13, 14, 15. Thus these other segments 6 can be made with regard to their width B using only comparatively few unidirectional fibers 23, which are embedded in synthetic resin 24. In addition, the length L is preferably much greater and the thickness D greater than the specified width B of these segments 6.

As shown in FIG. 2 and FIG. 6, an unfinished leaf spring 2 according to the second variant is constructed by means of these other segments 6 such that the following process steps are essentially followed:
Cutting of the other segments 6 from a web/strip of fiber composite material with an essentially right-angle cut (cut 22).
Placement of a number of these other segments 6 next to each other on their larger longitudinal sides 20, 21 such that an unfinished leaf spring 2 with a longitudinally layered structure is created, wherein the width of the material strip essentially has the thickness D of the unfinished leaf spring and the total of the segments 6 joined to each other at an angle to the longitudinal extension essentially determines the width of unfinished leaf spring 2.
Formation of a V-shaped final geometry 7 of unfinished leaf spring 2 caused by the segments 6 with differing axial lengths L resting closely against each other according to the directional arrows in FIG. 6.
Application of a clamping pressure on unfinished leaf spring 2 in a press mold and curing of the same using heat.

If it makes the production of leaf spring 1 easier, the segments 6 for creating unfinished leaf spring 2 may also be placed vertically on top of each other with their large longitudinal sides 20, 21, for example in a mold.

In the latter method, it is also possible to omit the production step of pivoting and placing axial legs closely against each other, because due to its longitudinally layered construction, the unfinished leaf spring can already have to a great extent the final geometry 25 of finished leaf spring 1 according to FIG. 1.

### DRAWING REFERENCE

In the following drawing reference, a descriptor is provided for each reference numeral appearing in the accompanying drawings. Note that like numerals designate like parts throughout the drawings, in which are shown, by way of illustration, specific embodiments in which the disclosure may be practiced. It is to be understood that other descriptors may be utilized and structural or logical changes may be made without departing from the scope of the present disclosure. Therefore, the following drawing references are not to be taken in a limiting sense. The drawings include references:

1 Leaf spring

2 Unfinished leaf spring

3 Central section

4 Axial end

5 Axial end

6 Segment

7 V-shaped recess or V-shaped final geometry

8 Leg

9 Leg

10 End section

11 End section

12 Longitudinal axis of leaf spring

13 Segment

14 Segment

15 Segment

16 Material web

17 Cut to create a segment 13, 14, 15

18 Short longitudinal side

19 Short longitudinal side

20 Longitudinal side

21 Longitudinal side

22 Cut, cut surface of a segment 6

23 Fiberglass

24 Synthetic resin

25 Final geometry of finished leaf spring 1

B Width of a segment 6

B1 Width of a segment 13, 14, 15

L Length of a segment 6

L1 Length of a segment 13, 14, 15

D Thickness of a segment 6

α Cutting angle

β Cutting angle

1. A leaf spring (1), produced from a fiber composite material, for a wheel suspension on a motor vehicle, comprising:
a central longitudinal section (3) constructed from resin-impregnated unidirectional fibers (23) and individual, geometrically largely identical elongate segments (6, 13, 14, 15), which are produced separately as fiber composite bodies and joined to the leaf spring (1, 2) prior to its curing; and
two adjoining axial end sections (10, 11), the resin-impregnated unidirectional fibers (23) extending axially, without being cut, between the axial ends (4, 5), the end sections (10, 11) are tapered in relation to the width of the leaf spring and, before an unfinished leaf spring (2) is finished, have a substantially V-shaped recess or a substantially V-shaped final geometry thereby forming two legs (8, 9) each that extend at an angle to the longitudinal extension of the unfinished leaf spring (2), said legs (8, 9) resting closely against each other in a finished leaf spring (1).

2. The leaf spring according to claim 1, wherein the segments (6, 13, 14, 15) are in the form of prepregs, which are cut out of a material web/strip (16) by means of two cuts (17, 17′) each, and are resting closely against each other on one each of their longitudinal sides (18, 19; 21, 22) to form the unfinished leaf spring (2).

3. The leaf spring according to claim 2, wherein two of the segments (13, 14) cut from the material web/strip (16), each with one of their respective longitudinal sides (18, 19) resting closely against each other such that in the top view the first segment (13) gives the right half of the leaf spring and the second segment (14) gives the left half of the leaf spring (1, 2), or vice versa.

4. The leaf spring according to claim 3, wherein the short longitudinal sides (18, 19) of the segments (13, 14) are placed close against each other to form the leaf spring (1, 2).

5. The leaf spring according to claim 3, wherein the groove angle of the substantially V-shaped final geometry (7) of the unfinished leaf spring (2) is identical to two times the cutting angle (α) when cutting the segments (13, 14) from the material web/strip (16).

6. The leaf spring according to claim 1, wherein the segments (13, 14) essentially have the thickness of the leaf spring (1, 2) vertical to their width (B1) and length (L1), or that several segments (13, 14) placed on top of each other give the thickness of the leaf spring (1, 2).

7. The leaf spring according to claim 1, wherein other segments (6) are cut from a material web/strip (16) with an essentially right-angle cut (22) having a width (B) at an angle to their length (L) that is smaller than the thickness (D) of these other segments (6), and that these other segments (6) rest closely against each other with their opposing larger longitudinal sides (20, 21) to form the unfinished leaf spring (2).

8. The leaf spring according to claim 1, wherein the segments (6) have differing axial lengths (L) to give the substantially V-shaped final geometry (7) of the unfinished leaf spring (2).

9. A method for producing a fiber composite leaf spring (1) according to claim 1, the steps comprising:
a) Cutting geometrically largely identical segments (13, 14) from a web/strip (16) of a fiber composite material with two cuts (17, 17′) each, using oblique cutting angles (α, β);
b) Separating the segments (13, 14);
c) Joining two segments (13, 14) on their short and narrow longitudinal sides (18, 19);
d) Repeating steps (a) through (c) until a desired thickness of the unfinished leaf spring (2) is achieved:
e) Pivoting/turning the four legs (8, 9) formed on the ends by the cuts (17, 17′) in the direction of the longitudinal axis (12) of the unfinished leaf spring (2) until the legs (8, 9) rest closely against each other; and
f) Applying a clamping pressure on the unfinished leaf spring (2) in a press mold and curing of the unfinished leaf spring (2) using heat.

10. Method for producing a fiber composite leaf spring (1), the steps comprising:
g) Cutting of other, geometrically largely identical segments (6) from a web/strip of a fiber composite material with an essentially right-angle cut (cut 22);
h) Placing a number of the other segments (6) next to or on top of each other on their larger longitudinal sides (20, 21) such that an unfinished leaf spring (2) with a longitudinally layered structure is created from the other segments, wherein the width of the material web/strip essentially has the thickness (D) of the unfinished leaf spring (2) and the total of the other segments (6) joined to each other at an angle to the longitudinal extension essentially determines the width of the unfinished leaf spring (2);
i) Forming a V-shaped final geometry of the unfinished leaf spring (2) caused by resting the other segments (6) with differing axial lengths (L) closely against each other;
j) Pivoting/turning of the longitudinally layered four legs (8, 9) in the direction of the longitudinal axis (12) of the unfinished leaf spring (2) until the legs (8, 9) rest closely against each other; and
k) Applying a clamping pressure on the unfinished leaf spring (2) in a press mold and curing of the unfinished leaf spring (2) using heat.

11. The leaf spring according to claim 4, wherein the groove angle of the substantially V-shaped final geometry (7) of the unfinished leaf spring (2) is identical to two times the cutting angle (α) when cutting the segments (13, 14) from the material strip/web (16).

12. The leaf spring according to claim 2, wherein the segments (13, 14) essentially have the thickness of the leaf spring (1, 2) vertical to their width (B1) and length (L1), or that several segments (13, 14) placed on top of each other give the thickness of the leaf spring (1, 2).

13. The leaf spring according to claim 3, wherein the segments (13, 14) essentially have the thickness of the leaf spring (1, 2) vertical to their width (B1) and length (L1), or that several segments (13, 14) placed on top of each other give the thickness of the leaf spring (1, 2).

14. The leaf spring according to claim 2, wherein other segments (6) cut from a material strip/web with an essentially right-angle cut (22) and having a width (B) at an angle to their length (L) that is smaller than the thickness (D) of these other segments (6), and that these other segments (6) rest closely against each other with their opposing larger longitudinal sides (20, 21) to give the unfinished leaf spring (2).

15. The leaf spring according to claim 2, wherein the other segments (6) have differing axial lengths (L) to give the substantially V-shaped final geometry (7) of the unfinished leaf spring (2).

16. The leaf spring according to claim 6, wherein the other segments (6) have differing axial lengths (L) to give the substantially V-shaped final geometry (7) of the unfinished leaf spring (2).

17. The leaf spring according to claim 7, wherein the other segments (6) have differing axial lengths (L) to give the substantially V-shaped final geometry (7) of the unfinished leaf spring (2).
